(19) United States
(12) Patent Application Publication
(10) Pub. No.: US 2012/0315180 A1
(43) Pub. Date: Dec. 13, 2012

(54) MUSIC STRING

(75) Inventors: Anders Soderman, Sandviken (SE); Lars Nylof, Gavle (SE)

(73) Assignee: SANDVIK INTELLECTUAL PROPERTY AB, Sandviken (SE)

(21) Appl. No.: 13/521,324

(22) PCT Filed: Dec. 22, 2010
(86) PCT No.: PCT/SE2010/000315

§ 371 Date: Aug. 24, 2012

Related U.S. Application Data
(60) Provisional application No. 61/293,822, filed on Jan. 11, 2010.

(30) Foreign Application Priority Data
Jan. 11, 2010 (SE) 1050015-5

(51) Int. Cl. G10D 3/10

(52) U.S. Cl. 420/38; 420/36; 420/49; 420/57; 420/58; 420/60; 420/61

(57) ABSTRACT

A stainless steel music string having a composition in percent by weight (wt %) of, 0.01≦C≦0.04; 0.01≦N≦0.06; 0.1≦Si≦1.0; 0.2≦Mn≦2.0; 5.0≦Ni≦10; 16≦Cr≦20; 0.2≦Cu≦3.0; 0≦Mo≦2.0; 0≦W≦0.5; 0≦V≦0.5; 0≦Ti≦1.0; 0≦Al≦1.0; 0≦Nb≦1.0; 0≦Co≦1.0, and the balance being Fe and normally occurring impurities The music string also includes at least 90% martensite phase by volume.

The present invention relates to a stainless steel music string.

### BACKGROUND

A music string, such as a string intended for electric guitars, needs to possess certain properties. Important properties are the yield strength and tensile strength of the string, i.e. the mechanical strength. The string needs to have a high enough tensile strength to be able to withstand the typical tension when stringed on an instrument and played on. The requirements on mechanical strength are dependant on the diameter of the string. Typical requirements on music strings suitable for electric guitars with regards to the minimum tensile strength for music strings of different dimensions are listed in Table 1.

Another property is the possibility of producing wire to the required dimensions. It must be possible to cold draw the string material down to fine wire diameters without the wire becoming brittle or even breaking. The main reason for such brittleness in stainless steel is the heavy deformation of the austenite phase and the resulting formation of strain induced martensite phase. Another example of a reason for brittleness is that the material contains intermetallic phases or particles which act as initiation points for cracking when the material is subjected to substantial deformation during wire production. Furthermore, the string may constitute a single wire, one or more twisted wires or a wrapped wire. This in turn renders a need for the material of the wire to be sufficiently ductile to be able to be twisted when in the form of a wire, i.e. in an already deformed state. The twistability of the string is important also for the anchoring of the string to the music instrument on which it is to be played. A music string is usually attached by using a barrel shaped ball end with a groove in the center. The string is looped onto itself so that the loop follows the groove around the ball end. The string is then twisted so that the ball end is retained by the loop. Typically music strings for electric guitars should be able to withstand the minimum number of twists listed in Table 1.

TABLE 1
Typical requirements for music strings for electric guitars.

| Dimension, | Dimension, | Min. tensile strength | |
|---|---|---|---|
| inch | mm | (MPa) | Min. no of twists |
| 0.010 | 0.254 | 2635 | 83 |
| 0.013 | 0.330 | 2442 | 63 |
| 0.017 | 0.432 | 2279 | 48 |

In the case of a string for electric instruments, such as an electric guitar, the sound generated by the string is highly dependent on the electromagnetic properties of the string. Most electric guitars employ electromagnetic pickups, although piezoelectric pickups are also used. The electromagnetic pickup consists of a coil with a permanent magnet. The vibrating strings cause changes in the magnetic flux through the coil, thus inducing electric signals in the coil. The signals are then transferred to a guitar amplifier where the signal is processed and amplified. The higher the magnetic susceptibility of a string is, the higher the voltage that is produced. This results in a higher input level to the amplifier and a more stable signal. It is therefore important that the string has a high content of magnetic phase, in order to achieve a high quality sound.

A string of a music instrument may be subjected to several different types of corrosion causing deterioration of the life time of the string. The corrosion will affect both the mechanical properties and the tuning properties over time. Corrosion will also affect the surface quality of the string and the tactility experienced by the player. One type of corrosion to which the string is subjected is atmospheric corrosion resulting from the environment in which the instrument is kept or operated. This corrosion may be substantial under for example humid conditions or in warm locations. For example, a music instrument which is used for outdoor playing may be subjected to substantial atmospheric corrosion over time. Furthermore, when playing a string, substances such as sweat or grease may be transferred from the musician's fingers to the string. Human sweat, which contains sodium chloride, will cause corrosion of the string by itself. Greasy substances transferred to the string will act as a binding means for other substances which may corrode the string, thereby forming a coating or film on the surface of the string.

Music strings are commonly made of regular high carbon steel alloy drawn to different wire diameters, a class of steel wires commonly referred to as “music wire”, but also strings made of nylon are used in some cases. Additionally strings made from nylon or carbon steel cores wrapped with a metal winding are used. Carbon steel has many good qualities as a music string material but also some major drawbacks. It is easy to draw carbon steels to high tensile strengths and yield strengths without encountering brittleness. Carbon steel also has the advantage of consisting almost entirely of magnetic phase material, since ferrite is the dominating phase in the structure of the material normally used for string applications. However, the corrosion properties of carbon steel are not sufficient. As described earlier, the major disadvantage of carbon steel strings is corrosion, and many attempts to arrest corrosion have been done with no success. Coating the steel strings with different materials such as metals or natural and synthetic polymers is one example of addressing the corrosion problem. However, coating generally decreases the string vibrations, which results in deteriorated sound quality. Coating also affects the surface quality of the string and small cracks or impurities in the coating may act as initiation points for corrosion.

WO2007/067135 discloses a music string made from precipitation hardenable martensitic stainless steel. Strings according to the WO2007/067135 have a high amount of magnetic phase and good corrosion properties. However, for certain applications, a further increase in ductility is of importance.

WO2007/058611 discloses a music string made from duplex (ferritic-austenitic) stainless steel. This steel has good corrosion properties and high mechanical strength. The material is also sufficiently ductile so that the string can be twisted. However, for electric instruments, it is advantageous with a higher amount of magnetic phase generating a higher and more stable electric signal.

Thus, there is a need for a stainless steel music string which has a tensile strength such that it can be stringed onto a music instrument and played on the same, which has a high ductility so that it can be twisted, and which has such a high content of magnetic phase so that it generates a high input level to the amplifier and a stable signal when played on electric instruments. From a production point of view, the stainless steel alloy used for the music string should possess good cold workability and enable a cost-effective manufacturing.

### SUMMARY OF THE INVENTION

The objective problem is to provide a stainless steel music string with high tensile strength, a high content of magnetic phase and a high ductility.

The problem is solved by the stainless steel music string as defined in claim 1.

The present invention provides a stainless steel music string comprising, in percent by weight (wt %):
0.01≦C≦0.04
0.01≦N≦0.06
0.1≦Si≦1.0
0.2≦Mn≦2.0,
5.0≦Ni≦10,
16≦Cr≦20,
0.2≦Cu≦3.0,
0≦Mo≦2.0,
0≦W≦0.5,
0≦V≦0.5,
0≦Ti≦1.0,
0≦Al≦1.0,
0≦Nb≦1.0,
0≦Co≦1.0,
the balance being Fe and normally occurring impurities.

The stainless steel music string should comprise at least 90% martensite phase by volume. Hereinafter, the stainless steel music string according to the invention is referred to as the music string.

The advantage of the music string according to the invention is that the high tensile strength and the high content of the magnetic martensite phase of the music string are combined with a retained ductility. A further advantage is that it is possible to achieve these properties in a cost-effective production route by cold working.

### BRIEF DESCRIPTION OF THE DRAWINGS

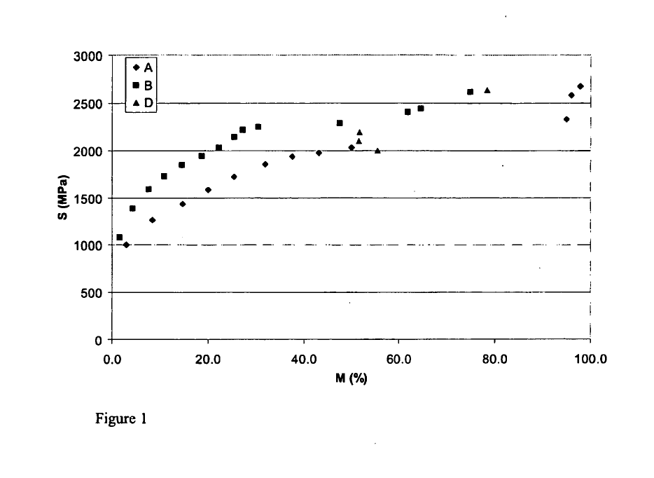

The invention will be described in detail with reference to the FIGURES, wherein FIG. 1 shows a graph of the tensile strength (S) versus the magnetic phase contents (M) for different experimental wire samples.

### DETAILED DESCRIPTION

The music string according to the present invention is made from a stainless steel alloy comprising, in percent by weight:
0.01≦C≦0.04
0.01≦N≦0.06
0.1≦Si≦1.0
0.2≦Mn≦2.0,
5.0≦Ni≦10,
16≦Cr≦20,
0.2≦Cu≦3.0,
0≦Mo≦2.0,
0≦W≦0.5,
0≦V≦0.5,
0≦Ti≦1.0,
0≦Al≦1.0,
0≦Nb≦1.0,
0≦Co≦1.0,
the balance being Fe and normally occurring impurities.

The music string comprises at least 90% by volume of the magnetic martensite phase. It has been found that this amount of deformation martensite phase is possible to achieve in a string of the above composition, without rendering the string too brittle.

By carefully balancing the amounts of the alloying elements described below both with regard to the effects of each separate element and to the combined effect of several elements, it has been found that a steel alloy is achieved which has excellent ductility and workability properties. Music strings manufactured from the steel alloy also as exhibits very much improved corrosion resistance compared to carbon steel strings or other similar materials. Furthermore, this is achieved without compromising the magnetic properties or the tensile strength of the music string.

Following is a description of the effects of the various elements of the steel alloy and a suitable range for each element.

Carbon (C) stabilizes the austenite phase of the steel alloy at high and low temperatures. Carbon also promotes deformation hardening by increasing the hardness of the martensite phase and, which to some extent is desirable in the steel alloy. Carbon further increases the mechanical strength which is an important property in a steel alloy used in string applications, where a low relaxation is needed. However, a high amount of carbon drastically reduces the ductility and the corrosion resistance of the steel alloy. The amount of carbon should therefore be limited to a range from 0.01 to 0.04 wt %.

Nitrogen (N) increases the resistance of the steel alloy towards pitting corrosion. Nitrogen also promotes the formation of austenite and depresses the transformation of austenite into deformation martensite phase during cold working. In addition to that, nitrogen also increases the mechanical strength of the steel alloy after completed cold working, which can be further extended by a precipitation hardening. However, higher amounts of nitrogen lead to increasing deformation hardening of the austenitic phase, which has a negative impact on the deformation force. To achieve a correct balance between the effect of stabilization of the austenitic phase and the amount of deformation martensite phase formed, i.e. the deformation hardening and the mechanical/magnetic properties of the end product, the content of nitrogen in the steel alloy should be limited to a range from 0.01 to 0.06 wt %.

Silicon (Si) is necessary for removing oxygen from the steel melt during manufacturing of the steel alloy. Silicon also promotes the formation of ferrite phase and in high amounts, silicon increases the tendency for precipitation of intermetallic phases. The amount of silicon in the steel alloy should therefore be limited to a range from 0.1 to 1.0 wt %.

Manganese (Mn) stabilizes the austenite phase and is therefore an important element in order to control the amount of free sulphur in the metal matrix, by the formation of manganese-sulphides in the steel alloy. Manganese also decreases the amount of ferrite phase formed in the steel alloy and promotes the solubility of nitrogen in the solid phase. Manganese will however increase the deformation hardening of the steel alloy, which increases the deformation forces and lowers the ductility, causing an enlarged risk of formation of cracks in the steel alloy during cold working. Increased amounts of manganese also reduce the corrosion resistance of the steel alloy, especially the resistance against pitting corrosion. The amount of manganese in the steel alloy should therefore be limited to a range from 0.2 to 2.0 wt %; preferably the amount of manganese is limited to a range from 0.5 to 1.5 wt %.

Nickel (Ni) promotes the formation of austenite and thus inhibits the formation of ferrite and improves ductility and to some extent the corrosion resistance. Nickel also controls the stability of the austenite phase and its ability to transform into martensite phase (deformation martensite) during cold working, which affects the mechanical and magnetic properties of the steel alloy. However, to achieve a proper balance between the structural phases and the properties of the steel alloy, the amount of nickel should be in the range from 5.0 to 10 wt %, preferably is the amount of nickel limited to a range from 8 to 9 wt %.

Chromium (Cr) is an important element of the stainless steel alloy since it provides corrosion resistance by the formation of a chromium-oxide layer on the surface of the steel alloy. Chromium affects the amount of deformation martensite formed during cold working, and by that indirectly controls the balance between the cold workability and the magnetic properties of the microstructure. However, at high temperatures the amount of ferrite phase (delta ferrite) increases with increasing chromium content which reduces the hot workability of the steel alloy. Chromium also promotes the solubility of nitrogen in the solid phase, which has a positive effect on the mechanical strength of the steel alloy. The amount of chromium in the steel alloy should therefore be in the range from 16 to 20 wt %, preferably is the amount of chromium limited to a range from 17 to 19 wt %.

Copper (Cu) increases the ductility of the steel and stabilizes the austenite phase and thus inhibits the austenite-to-martensite phase transformation during deformation which is critical for the cold workability and the magnetic properties of the alloy steel. Copper will also reduce the deformation hardening of the untransformed austenite phase during cold working, due to an increase in the stacking fault energy of the steel alloy. At high temperatures, a too high amount of copper sharply reduces the hot workability of the steel, due to an extended risk of exceeding the solubility limit for copper in the matrix and to the risk of forming brittle phases. Besides, copper promotes the formation of chromium nitrides, which may reduce the corrosion resistance and the ductility of the steel alloy. The amount of copper in the steel alloy should therefore be limited to a range from 0.2 to 3.0 wt %, preferably 0.5 to 1.5 wt %.

Molybdenum (Mo) greatly improves the corrosion resistance in most environments. However, molybdenum also has a strong stabilizing effect on the ferrite phase. Therefore, the amount of molybdenum in the steel alloy should be limited to a range from 0 to 2.0 wt %, preferably 0 to 1.0 wt % and more preferably 0 to 0.5 wt %.

Tungsten (W) stabilizes the ferrite phase and has a high affinity to carbon. However, high contents of tungsten in combination with high contents of Cr and Mo increase the risk of forming brittle intermetallic precipitations. Tungsten should therefore be limited to a range from 0 to 0.5 wt %, preferably 0 to 0.3 wt %.

Vanadium (V) stabilizes the ferrite phase and has a high affinity to carbon and nitrogen, acting as a precipitation hardening element. Vanadium should be limited to a range from 0 to 0.5 wt % in the steel alloy, preferably 0 to 0.3 wt %.

Titanium (Ti) stabilizes the delta ferrite phase and has a high affinity to nitrogen and carbon. Titanium can therefore be used to reduce the free amount of nitrogen and carbon in the matrix in order to reduce the formation of chromium carbides and nitrides during melting and welding. However, precipitation of carbides and nitrides during casting can disrupt the casting process. The formed carbon-nitrides can also act as defects causing a reduced corrosion resistance, toughness, ductility and fatigue strength. Titanium should be limited to a range from 0 to 1.0 wt %, preferably 0 to 0.5 wt %.

Aluminium (Al) is used as deoxidation agent during melting and casting of the steel alloy. Aluminium also stabilizes the ferrite phase and promotes precipitation hardening. Aluminium should be limited to a range from 0 to 1.0 wt %.

Niobium (Nb) stabilizes the ferrite phase and has a high affinity to nitrogen and carbon. Niobium can therefore be used to reduce the free amount of nitrogen and carbon in the matrix in order to reduce the formation of chromium carbides and nitrides during melting and welding. Niobium should be limited to a range from 0 to 1.0 wt %, preferably 0 to 0.5 wt %.

Cobalt (Co) has properties that are intermediate between those of iron and nickel. Therefore, a minor replacement of these elements with Co, or the use of Co-containing raw materials will not result in any major change in properties of the steel alloy. Co can also be used to increases the resistance against high temperature corrosion. Cobalt is an expensive element so it should be limited to a range from 0 to 1.0 wt %.

The music string according to the present invention comprises at least 90% martensite phase. The relationship between alloying elements controls the formation of martensite phase in the steel alloy and is therefore important for strength and ductility of the steel alloy. Low ductility at room temperature depends to a certain extent on deformation hardening, which is caused by the transformation of austenite into martensite phase during cold working of the steel alloy. Martensite phase increases the strength and hardness of the steel alloy. On the contrary, if too much martensite phase is formed in the steel alloy, it may be difficult to work in cold conditions, due to increased deformation forces. Too much martensite phase also decreases the ductility and may cause cracks in the steel alloy during cold working. However, since the martensite phase phase is magnetic, unlike the austenite phase, the amount of martensite phase formed in the microstructure during cold working controls the magnetic properties of the steel alloy. In addition to that, the properties of the martensite phase are very much dependent on the chemical composition of the steel alloy. In the present invention, it has been found that the ductility of the music string is high despite its large amount of martensite phase.

The stability of the austenite phase in the steel alloy during cold deforming may be determined by the MD30 value of the steel alloy. MD30 is the temperature, in ° C., where a deformation corresponding to ε=0.30 (logarithmic strain), leads to the conversion of 50% of the austenite to deformation martensite. Thus, a decreased MD30 temperature corresponds to an increased austenite stability, which will lower the deformation hardening during cold working, due to a reduced formation of deformation martensite. The MD30 value of the inventive steel alloy is defined as

MD30={551−462*([%C]+[%N])−9.2*[%Si]−8.1*[%Mn]−13.7*[%Cr]−29*([%Ni]+[%Cu])−68*[%Nb]−18.5*[%Mo]}° C. (1)

### Reference: K. Nohara, Y. Ono and N. Ohashi, Transactions ISIJ, vol. 17 p. 306, 1977

According to one embodiment, the alloying elements of the steel alloy are adjusted such that equation 1 fulfils the condition

−20° C.<MD30<20° C. (2)

Very good cold working properties and magnetic properties in combination with optimal mechanical strength and high ductility is achieved in the music string when this condition is fulfilled.

The music string according to the invention contains at least 90% martensite phase by volume, but still shows high ductility. According to one embodiment, the music string comprises as least 93% martensite phase by volume.

The music string according to the invention can be used e.g. as a string for an electric guitar or another electric instrument where the sound generated is dependent on the magnetic properties of the music string. However, the usage is not limited to electric instruments, but also acoustic instruments such as violins and pianos can advantageously be stringed with the music strings according to the invention. The music strings may be used for all string instruments, including stringed bow instruments.

The music strings according to the invention are not limited to single wires, but may also be in the form of wrapped or wounded music strings. The music string according to the invention may also comprise a core made of the inventive steel alloy, wrapped with metal strands.

Wire samples A with composition according to the invention and comparative wire samples B, C and D were produced. The compositions of the experimental samples are shown in Table 2. Comparative example B is made from a traditional metastable austenite alloy, example C is made from a precipitation hardenable martensitic stainless steel alloy as the one used in WO2007/067135, and example D is made from a duplex (ferritic-austenitic) stainless steel alloy as the one used in WO2007/058611. For reference, also a carbon steel wire sample of the type used for music strings was tested.

TABLE 2
Compositions of the experimental alloys.

| | Inventive alloy | Comparative alloys | | |
|---|---|---|---|---|
| | A | B | C | D |
| C | 0.029 | 0.083 | 0.012 | 0.012 |
| N | 0.033 | 0.025 | 0.010 | 0.18 |
| Si | 0.55 | 0.59 | 0.13 | 0.46 |
| Mn | 0.81 | 1.22 | 0.14 | 0.77 |
| Ni | 8.34 | 8.65 | 9.05 | 5.32 |
| Cr | 18.12 | 18.45 | 11.96 | 22.29 |
| Cu | 0.89 | 0.19 | 1.97 | 0.18 |
| Mo | 0.01 | 0.25 | 3.99 | 3.18 |
| W | 0.01 | <0.1 | <0.01 | <0.01 |
| V | 0.02 | <0.1 | 0.040 | 0.072 |
| Ti | 0.01 | <0.005 | 0.87 | 0.003 |
| Al | 0.01 | <0.003 | 0.30 | 0.009 |
| Nb | 0.01 | 0.01 | 0.01 | <0.01 |
| Co | 0.02 | 0.023 | <0.10 | 0.059 |

Wire samples of experimental alloys A, B, C, and D were tested for corrosion in a solution containing 40 mg of Sodium Thiosulfate and 1 g of sulfuric acid in order to simulate human sweat. The samples were placed in containers which were sealed and placed in an oven at 50° C. for 48 hours. The samples were then removed and analyzed.

The tensile strength of wire samples A, B, and D was determined according to standard SSEM 10002-1.

The amount of magnetic phase in the microstructure of the wire samples was measured using a magnetic balance. The weight of each wire sample was first determined using a precision balance. A pusher was then used to move the wire sample into the air gap of a saturation magnet. The magnetic moment was measured using Helmholtz measuring coils and a flux meter when the wire sample was pulled out of the magnet. The weight-specific saturation magnetism σₛ was calculated from the ratio of magnetic moment to weight. By dividing σₛ with σₘ, the theoretical weight-specific saturation magnetism according to Hoselitz (Hoselitz K., “Ferromagnetic Properties of Metals and Alloys”, Oxford University Press, 1952), the fraction of magnetic phase in the wire samples was obtained.

The wire samples A, C, D, and the carbon steel wire sample were twist tested in order to evaluate the torsion properties and ductility of the samples. A wire sample was passed through a chuck and fastened with both ends in a stationary holder. The chuck was then rotated at a constant speed so that the wire ends were twisted around each other. The distance between the chuck and the holder was 17 cm. The number of twists that the wire samples of each type can withstand without breaking was determined by calculating the mean values with a 95% confidence interval from a number of samples of each type.

All the stainless steel wire samples, A, B, C, and D showed good results after the corrosion testing. Minor corrosion attacks that could easily be wiped away could be seen on some samples. The carbon steel on the other hand showed severe corrosion attacks. It can be concluded from the test that all experimental stainless steel alloys exhibit corrosion properties superior to carbon steel.

The correlation between the maximum tensile strength obtainable by cold working without impairing the ductility and the amount of magnetic phase thus obtained for the different wire samples is found in Table 3. These results are also illustrated in FIG. 1. As can be seen, sample A exhibits more than 90% magnetic phase in the form of martensite phase when cold worked to high tensile strengths. For comparison, samples B and D exhibit less than 80% magnetic phase when cold worked to the tensile strengths required according to Table 1. Further cold working will cause brittleness of the samples. For music strings intended for electric instruments such as electric guitars, a high amount of magnetic phase in combination with high tensile strength is crucial. It can therefore be seen that sample A is very suitable for music strings in this regard.

TABLE 3
Amount of magnetic phase in % by volume and tensile strength of the wire
samples.

| | | | | D | |
|---|---|---|---|---|---|
| A | | B | | | Magnetic |
| Tensile | Magnetic | Tensile | Magnetic | Tensile | phase (%) |
| strength | phase (%) | strength | phase (%) | strength | (ferrite + |
| (MPa) | (martensite) | (MPa) | (martensite) | (MPa) | martensite) |
| 1004 | 2.9 | 1078 | 1.6 | | |
| 1261 | 8.3 | 1382 | 4.3 | | |
| 1435 | 14.6 | 1592 | 7.6 | | |
| 1587 | 20.0 | 1731 | 10.8 | | |
| 1725 | 25.4 | 1849 | 14.5 | | |
| 1854 | 31.9 | 1941 | 18.7 | | |
| 1934 | 37.5 | 2031 | 22.2 | | |
| 1972 | 43.1 | 2144 | 25.5 | | |
| 2027 | 50.0 | 2214 | 27.3 | | |
| 2330 | 94.9 | 2249 | 30.5 | 2000 | 55.4 |
| 2580 | 95.9 | 2287 | 47.6 | 2100 | 51.5 |
| 2674 | 97.8 | 2406 | 61.9 | 2190 | 51.6 |
| | | 2445 | 64.7 | 2634 | 78.4 |
| | | 2620 | 74.9 | | |

In Table 4, the results of twist testing for experimental wire samples A, C, D and for the comparative carbon steel wire sample are shown for samples of different dimensions. As can be clearly seen, the twistability of alloy A fulfills the requirements according to Table 1 and is superior to alloy C for all dimensions, and slightly better than alloy D for the two largest dimensions. For a music string, the twistability is important for the anchoring of the music string to the instrument as well as for the possibility of forming wrapped or twisted music strings.

TABLE 4
Tensile strength and twistability of wire samples A, C and D together with carbon steel.

| | A | | C | | D | | Carbon steel | |
|---|---|---|---|---|---|---|---|---|
| | Tensile | | Tensile | | Tensile | | Tensile | |
| Dimension | strength | Twist | strength | Twist | strength | Twist | strength | Twist |
| mm | (MPa) | test | (MPa) | test | (MPa) | test | (MPa) | test |
| 0.254 mm | 2662 | 112 ± 8 | 2735 | 37 ± 8 | 2721 | 116 ± 8 | 2922 | 157 |
| 0.330 mm | 2570 | 90 ± 6 | 2615 | 61 ± 3 | 2608 | 76 ± 4 | 2613 | 120 |
| 0.432 mm | 2345 | 87 ± 3 | 2403 | 14 ± 4 | 2360 | 76 ± 2 | 2449 | 90 |

From the experimental results, it can be concluded that the alloy that wire sample A is made from, which exhibits a good twistability in addition to high tensile strength and a high amount of magnetic phase, is very suitable for the production of music strings. A music string comprising the alloy of wire sample A thus fulfils the stated requirements.

1. Stainless steel music string comprising a composition in percent by weight (wt %), of:
0.01≦C≦0.04
0.01≦N≦0.06
0.1≦Si≦1.0
0.2≦Mn≦2.0,
5.0≦Ni≦10,
16≦Cr≦20,
0.2≦Cu≦3.0,
0≦Mo≦2.0,
0≦W≦0.5,
0≦V≦0.5,
0≦Ti≦1.0,
0≦Al≦1.0,
0≦Nb≦1.0,
0≦Co≦1.0,
the balance being Fe and normally occurring impurities, and the music string comprising at least 90% martensite phase by volume.

2. Stainless steel music string according to claim 1, wherein 0.5≦Mn≦1.5 in percent by weight.

3. Stainless steel music string according to claim 1, wherein 8.0≦Ni≦9.0 in percent by weight.

4. Stainless steel music string according to claim 1, wherein 17≦Cr≦19 in percent by weight.

5. Stainless steel music string according to claim 1, wherein 0.5≦Cu≦1.5 in percent by weight.

6. Stainless steel music string according to claim 1, wherein 0≦Mo≦1.0 in percent by weight.

7. Stainless steel music string according to claim 1, wherein 0≦Mo≦0.5 in percent by weight.

8. Stainless steel music string according to claim 1, wherein 0≦W≦0.3 in percent by weight.

9. Stainless steel music string according to claim 1, wherein 0≦V≦0.3 in percent by weight.

10. Stainless steel music string according to claim 1, wherein 0≦Ti≦0.5 in percent by weight.

11. Stainless steel music string according to claim 1, wherein 0≦Nb≦0.5 in percent by weight.

12. Stainless steel music string according to claim 1, wherein the music string comprises at least 93% martensite phase by volume.

13. Stainless steel music string according to claim 1, wherein −20° C.<MD30<20° C., wherein
MD30={551−462*([%C]+[%N])−9.2*[%Si]−8.1*[%Mn]−13.7*[%Cr]−29*([%Ni]+[%Cu])−68*[%Nb]−18.5*[%Mo]}° C.
